(19) United States
(12) Patent Application Publication
(10) Pub. No.: US 2022/0222409 A1
(43) Pub. Date: Jul. 14, 2022

(54) METHOD AND SYSTEM FOR PREDICTING REMAINING USEFUL LIFE OF ANALOG CIRCUIT

(71) Applicant: WUHAN UNIVERSITY, HUBEI (CN)

(72) Inventors: Yigang HE, Hubei (CN); Bolun DU, Hubei (CN); Lei WANG, Hubei (CN); Liulu HE, Hubei (CN); Zhikai XING, Hubei (CN)

(73) Assignee: WUHAN UNIVERSITY, HUBEI (CN)

(21) Appl. No.: 17/507,750

(22) Filed: Oct. 21, 2021

(30) Foreign Application Priority Data
Jan. 12, 2021 (CN) 202110034936.6

(51) Int. Cl. G06F 30/36

(52) U.S. Cl. CPC G06F 30/36; G06F 2119/12

(57) ABSTRACT

A method and a system for predicting remaining useful life of an analog circuit are provided. A simulation model of the analog circuit is built, and an output voltage is selected as a degradation variable. Different degradation cycles are set to extract degradation features of the output voltage. Key features that can reflect a degradation trend of a circuit component are selected. Multi-feature fusion and similarity model are adopted to construct a health indicator curve to characterize a degradation process of a full life cycle of different circuit components. A prediction model is established based on a temporal convolutional network and an attention mechanism, and preferably selected features and a constructed health indicator database are used as an input of a TCN-attention network to predict the remaining useful life of the circuit component.

### CROSS-REFERENCE TO RELATED APPLICATION

This application claims the priority benefit of China application serial no. 202110034936.6, filed on Jan. 12, 2021. The entirety of the above-mentioned patent application is hereby incorporated by reference herein and made a part of this specification.

### BACKGROUND

### Technical Field

The disclosure relates to the field of life prediction of the analog circuit, and more specifically relates to a method and a system for predicting remaining useful life of an analog circuit.

### Description of Related Art

Most prognostics and health management (PHM) researches for the analog circuit focus on the aspect of failure diagnosis of the analog circuit, and only a small number of researches are relevant to the failure prediction of the analog circuit. The failure diagnosis of the analog circuit is to measure, analyze, and process abnormal output information of the analog circuit after a failure occurs, thereby identifying the failure that has occurred to isolate and locate the failure. The disadvantage is that various unfavorable consequences caused by the failure cannot be prevented. The failure prediction of the analog circuit is to measure response data at the output end and establish a failure prediction model through machine learning of the degradation mechanism thereof, thereby performing failure prediction.

The degradation of a circuit component usually causes parameter values of the circuit component to deviate from nominal values thereof, which will ultimately affect the stable operation of the circuit. For example, the aging of the capacitor causes operation parameters to be reduced, resulting in the short-circuit of the capacitor and sometimes explosion, and even damage to the equipment and threat to personal safety. Therefore, the prediction of the remaining useful life (RUL) of the analog circuit is of great significance for the evaluation of the operation state, the failure warning, the predictive maintenance, the improvement of the operation reliability, the safety, etc. of the analog circuit.

The RUL prediction of the analog circuit may be divided into the model-based method and the data-driven method. The weakness, suddenness, randomness, non-linearity, and real-time data update of the failure of the analog circuit all bring difficulties to the failure prediction of the analog circuit.

### SUMMARY

In view of the above defects or improvement requirements of the prior art, the disclosure proposes a method and a system for predicting remaining useful life of an analog circuit. For components such as a capacitor and an inductor of the analog circuit, accurate and efficient prediction of the remaining useful life is provided to ensure safe operation of the circuit.

In order to achieve the above objective, according to one aspect of the disclosure, a method for predicting remaining useful life of an analog circuit is provided, which includes the following steps.

In Step (1), a simulation model of the analog circuit is established, a degradation process of a circuit component is simulated through adjusting a value of the circuit component to gradually deviate from a nominal value, and an output voltage of the circuit is selected as a degradation variable.

In Step (2), a tolerance range and a degradation threshold of the circuit component are set, the degradation variable of each degradation cycle is collected, and corresponding degradation features are extracted.

In Step (3), a feature parameter optimal rule for extracting various analog circuits is established, and key features that can quantitatively characterize a degree of degradation of the circuit component are preferably selected.

In Step (4), feature parameter deviations between different degradation states and healthy states of the circuit component are calculated to construct a health indicator curve for quantifying the degree of degradation of the circuit component.

In Step (5), a prediction model based on a temporal convolutional network (TCN) and an attention mechanism is adopted to learn preferably selected key feature data and corresponding health indicator curve data, and the remaining useful life of the circuit component is predicted.

In some alternative embodiments, Step (2) specifically includes the following.

For the degradation variable collected in each degradation cycle, a deep learning feature extraction method is adopted to extract intermediate layer information as initial features.

A feature extraction method based on statistical theory is adopted to analyze and process the extracted initial features to obtain the degradation features of the analog circuit.

A feature extraction method based on time domain analysis is adopted to analyze and process the extracted initial features to obtain the degradation features of the analog circuit.

A feature extraction method based on amount of information is adopted to analyze and process the extracted initial features to obtain the degradation features of the analog circuit.

In some alternative embodiments, Step (3) specifically includes the following.

In Step (3.1), an optimal feature indicator is comprehensively integrated based on monotonicity of the degradation features of the circuit component and trend of the degradation features of the circuit component to eliminate redundant degradation features that do not change along with the degradation cycle and obtain retained degradation features.

In Step (3.2), a maximum information coefficient (MIC) is adopted to calculate a correlation between the retained degradation features to filter out the key features that have deep non-linear correlation between each other in the entire degradation cycle through the maximum information coefficient (MIC). The higher the MIC value, the higher the correlation between the degradation features.

In some alternative embodiments, Step (3.2) specifically includes the following.

A correlation symmetric matrix,

$$H = [ \begin{matrix}1 ( {m}_{11} ) & . . . & {m}_{1 j} & . . . & {m}_{1 k} & ⋮ & {Mean}_{1} \\ ⋮ & ⋱ & ⋮ & & ⋮ & ⋮ & ⋮ \\ {m}_{j 1} & & 1 ( {m}_{jj} ) & & {m}_{jk} & ⋮ & {Mean}_{j} \\ ⋮ & & ⋮ & ⋱ & ⋮ & ⋮ & ⋮ \\ {m}_{k 1} & . . . & {m}_{kj} & . . . & 1 ( {m}_{kk} ) & ⋮ & {Mean}_{k}\end{matrix} ] ,$$

is established, wherein mⱼₖ represents an MIC value between a j-th degradation feature and a k-th degradation feature, and diagonal values are all 1.

Due to the symmetry of the matrix, a mean MIC of each line is Mean=(Mean₁, . . . , Meanⱼ, . . . , Meanₖ), wherein Meanⱼ is an indicator for selecting a most optimal feature and reflects a degree of correlation between all other degradation features and the j-th degradation feature, and

$$\{ \begin{matrix}{Mean}_{j} \geq σ \\ σ = \frac{1}{M} {\sum }_{i = 1}^{M} {Mean}_{j}\end{matrix} ,$$

j=1, 2, . . . , M, wherein σ is a threshold of optimal features, and M is a number of degradation features participating in correlation calculation.

In some alternative embodiments, Step (4) specifically includes the following.

After preferably selecting the key features that can quantitatively characterize the degree of degradation of the circuit component, multi-feature fusion and similarity model are adopted to construct the health indicator curve of the circuit component for characterizing the degradation process of the circuit component exceeding the tolerance range.

The degradation thresholds of different circuit components are determined, a database of the health indicator curves of all circuit components is established, and the database is used together with the degradation features as an input of a prediction network.

In some alternative embodiments, Step (5) specifically includes the following.

Health indicator labels are added to the degradation features after feature optimization to cover the degradation process of a full life cycle of the circuit component from a healthy state to failure and divide into a training set and a test set. The training set is input into a TCN-attention network for model training. In a test stage, the test set is input into a trained model to predict the remaining useful life of the circuit component.

In some optional implementations, the TCN-attention network includes a temporal convolutional network layer, an attention mechanism layer, and a fully connected layer. The temporal convolutional network layer is a new network structure formed by stacking dilated convolutions and causal convolutions while combining residuals.

According to another aspect of the disclosure, a system for predicting remaining useful life of an analog circuit is provided, which includes the following.

A degradation variable acquisition module is used to establish a simulation model of the analog circuit, simulate a degradation process of a circuit component through adjusting a value of the circuit component to gradually deviate from a nominal value, and select an output voltage of the circuit as a degradation variable.

A degradation feature extraction module is used to set a tolerance range and a degradation threshold of the circuit component, collect the degradation variable of each degradation cycle, and extract corresponding degradation features.

An optimal feature module is used to establish a feature parameter optimal rule for extracting various analog circuits and preferably select key features that can quantitatively characterize a degree of degradation of the circuit component.

A health indicator curve construction module is used to calculate feature parameter deviations between different degradation states and healthy states of the circuit component to construct a health indicator curve for quantifying the degree of degradation of the circuit component.

A prediction module is used to adopt a prediction model based on a temporal convolutional network (TCN) and an attention mechanism to learn preferably selected key feature data and corresponding health indicator curve data, and predict the remaining useful life of the circuit component.

According to another aspect of the disclosure, a computer-readable storage medium stored with a computer program is provided. When the computer program is executed by a processor, the steps of the method according to any one of the above are implemented.

Generally speaking, compared with the prior art, the above technical solutions conceived by the disclosure can achieve the following beneficial effects.

The tolerance of each circuit component is considered, the feature overlap phenomenon during degradation feature extraction in the prior art is solved, and the issue that unfavorable factors such as noise interference and measurement error make it difficult to implement prediction of the full life cycle is solved.

The issue of ineffective learning and poor generalization when commonly used RUL prediction algorithms (shallow networks such as support vector regression and correlation vector regression) process large amounts of interference feature data is solved.

### BRIEF DESCRIPTION OF THE DRAWINGS

FIG. 1 is a schematic flowchart of a method for predicting remaining useful life according to an embodiment of the disclosure.

FIG. 2 is a schematic diagram of a topological structure of an analog circuit according to an embodiment of the disclosure.

FIG. 3 is a schematic diagram of an output voltage of an analog circuit according to an embodiment of the disclosure.

FIG. 4 is a result diagram of feature extraction of an analog circuit according to an embodiment of the disclosure.

FIG. 5 is a database of health indicator curves of circuit components according to an embodiment of the disclosure.

FIG. 6 is a model structure diagram of a remaining useful life prediction algorithm according to an embodiment of the disclosure.

FIG. 7 is a result diagram of remaining useful life prediction of an analog circuit according to an embodiment of the disclosure.

### DETAILED DESCRIPTION OF DISCLOSED EMBODIMENTS

In order for the objectives, technical solutions, and advantages of the disclosure to be clearer, the following further describes the disclosure in detail with reference to the accompanying drawings and embodiments. It should be understood that the specific embodiments described here are only used to explain the disclosure, but not to limit the disclosure. In addition, the technical features involved in the various embodiments of the disclosure described below may be combined with each other as long as there is no conflict therebetween.

The prediction method of remaining useful life (RUL) according to the disclosure only needs to run various data analysis method processing on collected information and data, and then apply a machine learning method to perform RUL prediction. Therefore, the complex dynamic modeling process of the model-based prediction method according to operation conditions of a circuit and failure mechanisms of a circuit component is avoided.

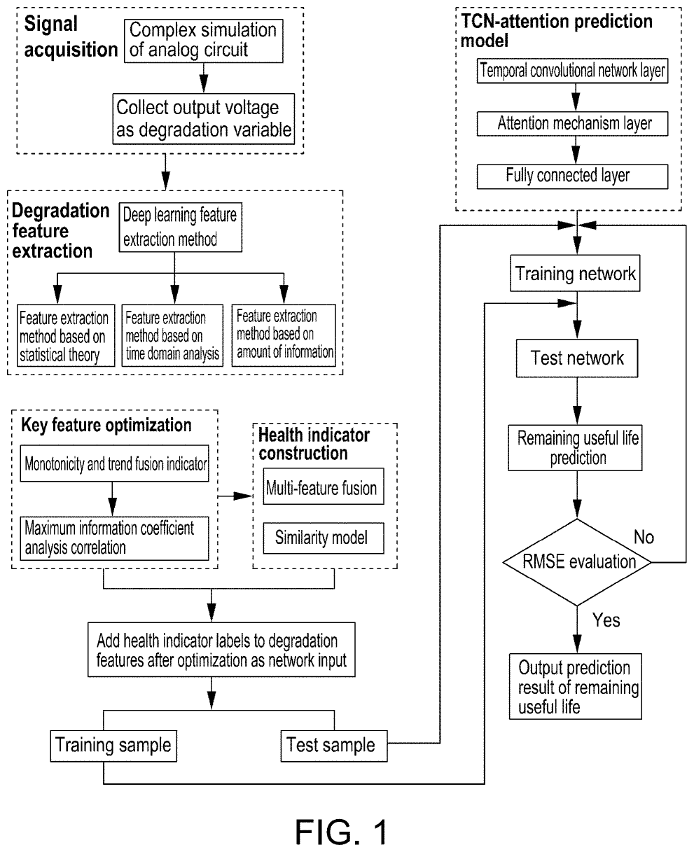

FIG. 1 is a schematic flowchart of a method for predicting remaining useful life of an analog circuit according to an embodiment of the disclosure. The specific steps are as follows.

In Step S1, a semi-physical simulation experiment platform of an analog circuit is built, different degradation states are simulated through adjusting a circuit component to gradually deviate from a nominal value, and an output voltage of the circuit is selected as a degradation variable, specifically as follows.

In Step S1.1, firstly, MATLAB/Simulink is used to establish models such as topology and degradation parameter controller of the analog circuit, and the circuit is then run in real time through RT-LAB to complete the system design. Secondly, main circuit components in the analog circuit that need the remaining useful life to be predicted include a capacitor, a resistor, an inductor, etc. In the hardware design stage of the degradation parameter controller, an RT-LAB semi-physical simulation platform is used to connect to a computer, and performance degradation tests of different circuit components are set up to complete the development of the degradation parameter control strategy. Finally, various signal data of the analog circuit is collected to analyze electrical signal parameters that are sensitive to performance degradation of circuit components. A degradation database containing degradation component types, degradation cycles, circuit system voltage outputs, etc., of circuit components such as the capacitor, the inductor, and the resistor is constructed for subsequent research on feature extraction, feature optimization, and the prediction method of the remaining useful life.

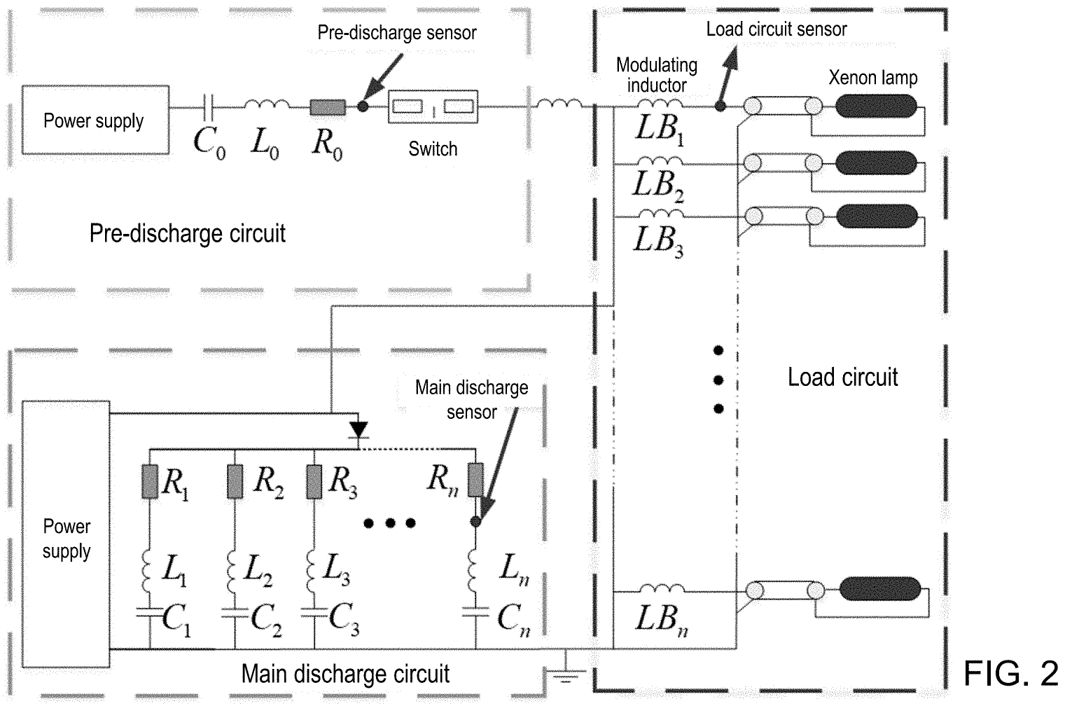

In Step S1.2, the simulated topological structure of the analog circuit analyzed in the embodiment of the disclosure is shown in FIG. 2 and mainly consists of a pre-discharge circuit, a main discharge circuit, and a load circuit. The pre-discharge circuit contains a pre-discharge capacitor, a pre-discharge sensor, and a pre-discharge resistor. The main discharge circuit is composed of multiple branches, and each branch contains a main discharge capacitor, a main discharge sensor, and a main discharge resistor. The load circuit contains a modulating inductor and a xenon lamp. The workflow of the analog circuit is that the pre-discharge circuit generates a pulse for a certain duration to trigger the xenon lamp and the main discharge circuit. After triggering the pre-discharge circuit, the main discharge capacitor discharges to provide pulse energy for the xenon lamp of the load circuit.

In Step S2, degradation parameters are set according to the type and the location of the degraded circuit component, specifically as follows.

In Step S2.1, the value of the circuit component cannot indefinitely increase or decrease. It is necessary to define a relationship between the tolerance range and the degradation threshold according to features of different circuit components. The influence of degradation of different components on distortion of an output voltage waveform of the analog circuit is different. According to the importance of circuit components, the tolerance range is divided into four cases: resistance is ±10%, main discharge capacitance/main discharge inductance is ±5%, pre-discharge capacitance/pre-discharge inductance is ±3%, and modulating inductance is ±1%. The degradation threshold of each circuit component is defined to deviate from the nominal value by ±40%.

In Step S2.2, the degradation parameters of the circuit component are set. Table 1 shows the tolerance ranges and the degradation thresholds of different circuit components. The calculation equation of the degradation threshold is as follows:

$$\{ \begin{matrix}{Value}_{Failure \_ ↑} = 1.3 \times V a l u {e}_{0} , if ↑ \\ {Value}_{Failure \_ ↓} = 0.7 \times {Value}_{0} , if ↓\end{matrix} \qquad ( 1 )$$

wherein ↑ and ↓ indicate an increase and a decrease in a parameter value of the circuit component, Value_{Failure_↑} represents the degradation threshold of the increase in the parameter value of the circuit component, Value_{Failure_↓} represents the degradation threshold of the decrease in the parameter value of the circuit component, and Value₀ represents the nominal value of the circuit component. The circuit component is set to uniformly degrade, that is, the parameter value of the circuit component equally increment/decrement along with the degradation cycle, which is defined as follows:

$$\{ \begin{matrix}C y c l {e}_{F a i l u r {e}_{-} ↑} = ( V a l u {e}_{{Failure}_{-} max} - {Value}_{0} ) / Valu {e}_{1} \\ C y c l {e}_{F a i l u r {e}_{-} ↓} = ( {Value}_{0} - {Value}_{F a i l u r {e}_{-} min} ) / {Value}_{1}\end{matrix} \qquad ( 2 )$$

wherein Value₁ represents the parameter value of the increment/decrement of the circuit component in each degradation cycle, Cycle_{Failure_↑} represents the degradation cycle of the circuit component incrementing to reach the degradation threshold, Cycle_{Failure_↓} represents the degradation cycle of the circuit component decrementing to the degradation threshold, Value_{Failure_max} represents a maximum value of the increase in the parameter value of the circuit component, and Value_{Failure_min} represents a minimum value of the decrease in the parameter value of the circuit component.

TABLE 1
Tolerances and degradation thresholds of different circuit components

| Degraded | Nominal | | Tolerance | | Degradation | | Degradation value of | | degradation |
|---|---|---|---|---|---|---|---|---|---|
| component | value | | value | | threshold | | degradation cycle | | cycle |
| (C_{1~10})↑ | 90 | μF | 94.5 | μF | 126 | μF | (180~360) | nF | 100~200 |
| (C_{1~10})↓ | 90 | μF | 85.5 | μF | 54 | μF | (180~360) | nF | 100~200 |
| (L_{1~10})↑ | 150 | μH | 157.5 | μH | 210 | μH | (300~600) | nH | 100~200 |
| (L_{1~10})↓ | 150 | μH | 142.5 | μH | 90 | μH | (300~600) | nH | 100~200 |
| C₀↑ | 15 | μF | 15.45 | μF | 21 | μF | (30~60) | nF | 100~200 |
| C₀↓ | 15 | μF | 14.55 | μF | 9 | μF | (30~60) | nF | 100~200 |
| L₀↑ | 100 | μH | 103 | μH | 140 | μH | (0.2~0.4) | μH | 100~200 |
| L₀↓ | 100 | μH | 97 | μH | 60 | μH | (0.2~0.4) | μH | 100~200 |
| L_{B(1~10)}↑ | 30 | μH | 30.3 | μH | 42 | μH | (30~60) | nH | 100~200 |
| L_{B(1~10)}↓ | 30 | μH | 29.7 | μH | 18 | μH | (30~60) | nH | 100~200 |

In Step S2.3, when a circuit component in the circuit undergoes a degradation experiment, other circuit components are working under healthy states, that is, change within the tolerance range, the output voltage of the analog circuit is collected, and the degradation of different circuit components has different influences on the output voltage, specifically as follows.

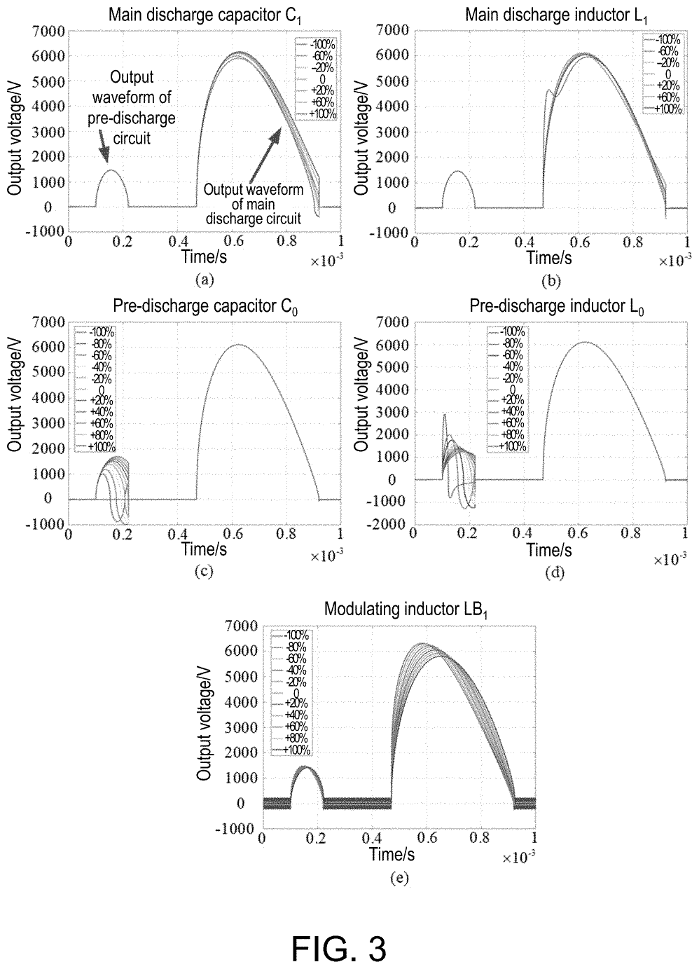

In Step S2.3.1, the degradation of the main discharge capacitor and the main discharge inductor only affects the output voltage waveform of the main discharge circuit. The main discharge circuit has multiple branches, and the failure of one circuit component has little influence on the circuit system. In (a) and (b) of FIG. 3, output voltage responses corresponding to different degrees of degradation of a main discharge capacitor C₁ and a main discharge inductor L₁ are shown.

In Step S2.3.2, the pre-discharge circuit plays a crucial transitional role before the main discharge circuit is discharged. The performance degradation of the pre-discharge capacitor and the pre-discharge sensor only affects the output voltage of the pre-discharge circuit. In (c) and (d) of FIG. 3, output voltage responses corresponding to different degrees of degradation of a pre-discharge capacitor C₀ and a pre-discharge inductor L₀ are shown.

In Step S2.3.3, the function of the modulating inductor is to evenly distribute current in each branch of the load circuit. Once the performance of the modulating inductor is degraded, the voltage waveforms of the main discharge circuit and the pre-discharge circuit will be distorted. In (e) of FIG. 3, an output voltage response corresponding to different degrees of degradation of a modulating inductor LB₁ is shown.

In Step S3, the degradation features that can characterize the performance degradation process of the circuit component are extracted from the output voltages collected in different degradation cycles, specifically as follows.

In Step S3.1, a deep learning feature extraction method such as a deep belief network and a stacked autoencoder is adopted, an input node, an output node, and the number of layers are set, and a non-linear mapping manner is used to extract intermediate layer information as initial features.

In Step S3.2, a feature extraction method based on statistical theory (such as KL transformation, principal component analysis, and factor analysis) is adopted to analyze and process the initial features extracted in Step S3.1 to obtain the degradation features of the analog circuit.

In Step S3.3, a feature extraction method based on time domain analysis is adopted to perform time domain analysis and time domain changes on the initial features to obtain time domain features thereof, and then respectively perform dimensionality reduction and normalization, thereby extracting the degradation features of the analog circuit. Here, the time domain analysis includes Fourier transform, wavelet analysis, Hilbert-Huang transform, etc.

In Step S3.4, a feature extraction method based on amount of information is adopted to extract a mean, a standard deviation, an entropy, a kurtosis, a skewness, a centroid, etc. of the initial features, and the degradation features that may characterize the analog circuit are explored in the amount of information.

In Step S4, on the basis of the various feature extraction methods, key features that are more suitable for characterizing a degradation trend of the circuit component are preferably selected from all the degradation features obtained from the various feature extraction methods, specifically as follows.

In Step S4.1, monotonicity of the degradation features of the circuit component is calculated with the equation as follows:

$$Mon ( X ) = \frac{\vert N0 . of \frac{d}{d x} > 0 - N0 . of \frac{d}{d x} < 0 \vert}{m - 1} \qquad ( 3 )$$

wherein X={x₁, x₂, . . . , xₘ} represents the degradation features of the circuit component, m is the number of degradation features,

$$\frac{d}{d x} = {x}_{m} - {x}_{m - 1}$$

represents a difference between two adjacent degradation cycles in the degradation features, and

$$N0 . of \frac{d}{d x} > 0 and N0 . of \frac{d}{d x} < 0$$

respectively represent a positive difference and a negative difference. The range of Mon(X) is 0 to 1, and the greater the value, the better the monotonicity.

Then, the trend of the degradation features of the circuit component is calculated with the equation as follows:

$$Trend ( X ) = \begin{matrix}min \\ i , j\end{matrix} ( \vert corrcoef ( {x}_{i} , {x}_{j} ) \vert ) , i , j = 1 , 2 , … , m \qquad ( 4 )$$

wherein xᵢ, xⱼ represents extracted i-th and j-th degradation features, and corrcoef(xᵢ, xⱼ) calculates a degree of trend between the degradation feature xᵢ and the degradation feature xⱼ.

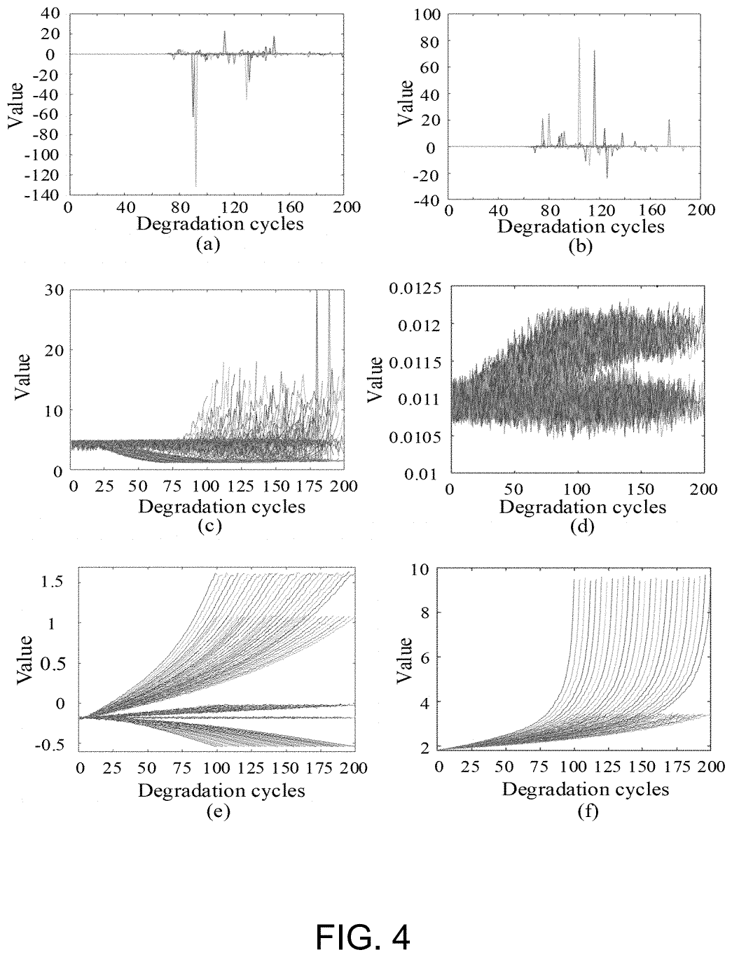

FIG. 4 shows a part of the degradation features of the analog circuit. It can be seen that not all the extracted degradation features can well characterize the degradation process of the circuit component. As shown in (a) and (b) of FIG. 4, the part of the degradation features does not change along with the degradation cycle and needs to be eliminated. After deleting features that hardly change along with the degradation cycle via a monotonicity and trend fusion feature optimization indicator, deviation of a single indicator may be avoided. The fusion feature optimization indicator is as follows:

$$\begin{matrix}max \\ 1 \int m\end{matrix} CSC = {ω}_{1} M o n + {ω}_{2} Trend ; s . t . {\sum }_{k = 1}^{2} {ω}_{k} = 1 , {ω}_{k} > 0 \qquad ( 5 )$$

wherein ωₖ, k=1, 2 represents a weighting coefficient and CSC represents the fusion feature optimization indicator.

In Step S4.2, as shown in (c) and (d) of FIG. 4, the part of the features shows a certain trend of degradation, but the correlation between the features is very poor and needs to be eliminated. The features in (e) and (f) of FIG. 4 show a regular trend of degradation, which may improve the accuracy of the prediction of the remaining useful life. A maximum information coefficient (MIC) between any two features in a feature set after optimization in Step (4.1) is calculated.

Then, a correlation symmetric matrix is established, wherein mⱼₖ represents an MIC value between the j-th feature and the k-th feature, and diagonal values are all 1. The correlation matrix is as follows:

$$H = [ \begin{matrix}1 ( {m}_{11} ) & … & {m}_{1 j} & … & {m}_{1 k} & ⋮ & {Mean}_{1} \\ ⋮ & ⋱ & ⋮ & & ⋮ & ⋮ & ⋮ \\ {m}_{j 1} & & 1 ( {m}_{j j} ) & & {m}_{j k} & ⋮ & Mea {n}_{j} \\ ⋮ & & ⋮ & ⋱ & ⋮ & ⋮ & ⋮ \\ {m}_{k 1} & … & {m}_{k j} & … & 1 ( {m}_{k k} ) & ⋮ & Mea {n}_{k}\end{matrix} ] \qquad ( 6 )$$

The higher the MIC value, the higher the correlation between the degradation features, and the better the characterization of the degradation trend of the healthy state of the circuit component. Due to the symmetry of the matrix, a mean MIC of each line is Mean=(Mean₁, . . . , Meanⱼ, . . . , Meanₖ), wherein Meanⱼ reflects a degree of correlation between all other degradation features and the j-th degradation feature and may be used as an indicator for selecting a most optimal feature, and the equation is as follows:

$$\{ \begin{matrix}{Mean}_{j} \geq σ \\ σ = \frac{1}{M} {\sum }_{i = 1}^{M} {Mean}_{j}\end{matrix} , j = 1 , 2 , … , M \qquad ( 7 )$$

wherein σ is a threshold of optimal features and is calculated from the MIC means of all features, and M is a number of degradation features participating in correlation calculation.

In Step S5, according to the degradation features after optimization, a health indicator database of the circuit components is constructed, and the remaining useful life is calculated, specifically as follows.

In Step S5.1, the health indicator database is constructed.

A health indicator curve is composed of multiple degradation features and relevant weights thereof, which may characterize the degradation process of the circuit component along with the degradation cycle. The degradation features after optimization are used as a regression function, and a multi-feature fusion model is used to calculate the health indicator curve as follows:

Y=b+w₁·x₁+w₂·x₂+ . . . +wₚ·xₚ (8)

wherein x₁, x₂, . . . , xₚ is degradation feature data after optimization, p is a number of degradation features after optimization, b is the deviation, Y represents the health indicator curve, and w₁, w₂, . . . , wₚ represents weights with different values.

Equation (8) may calculate and establish a health indicator curve database Y={Y⁽¹⁾, Y⁽²⁾, . . . , Y⁽ⁱ⁾, . . . , Y⁽ⁿ⁾} wherein n represents a number of corresponding circuit components in the constructed health indicator curve database. When a corresponding healthy state value Yₜ⁽ⁱ⁾ may be found for a given degradation cycle t, any health indicator curve Y⁽ⁱ⁾ may be used to describe a full life cycle of a circuit component degrading from a healthy state to failure, and the equation is as follows:

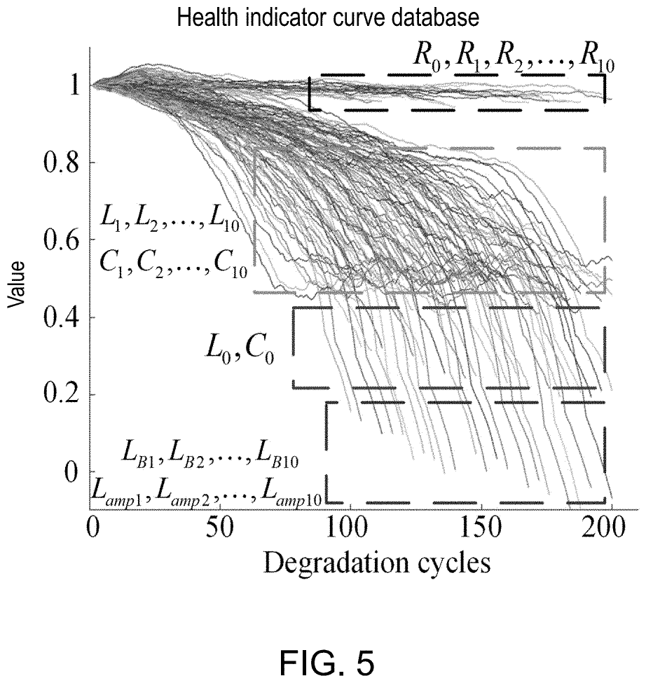

Y⁽ⁱ⁾=[Y₁⁽ⁱ⁾,Y₂⁽ⁱ⁾, . . . ,Yₜ⁽ⁱ⁾, . . . ,Y_{L}_{⁽ⁱ⁾}⁽ⁱ⁾], 0≤t≤L⁽ⁱ⁾, i=1,2, . . . ,n (9)

wherein L⁽ⁱ⁾ (i=1, 2, . . . , n) represents a threshold of the degradation cycle of the circuit component. FIG. 5 shows the health indicator curve database Y={Y⁽¹⁾, Y⁽²⁾, . . . , Y⁽ⁱ⁾, . . . , Y⁽ⁿ⁾} of the circuit component. The sliding time window processing technology is adopted to fully learn time series information of a degradation feature sample. Preferably selected key degradation features and the constructed health indicator curve database are input into a prediction network to implement model training and predict the remaining useful life of the circuit component.

In Step S5.2, a remaining useful life database for network prediction is calculated.

The circuit component starts degrading from the healthy state until failure. Therefore, an initial value of the health indicator curve is 1. As the degradation cycle increases, the health indicator curve decreases and the value approaches 0 when the circuit component fails. The healthy state database Y={Y⁽¹⁾, Y⁽²⁾, . . . , Y⁽ⁱ⁾, . . . , Y⁽ⁿ⁾} of the circuit component may be used as a scale to measure the remaining useful life database. Since in the simulation of the analog circuit, parameter values of all circuit components are linearly degraded, a relationship between the remaining useful life (RUL) and the health indicator (HI) curve is defined as follows:

$$\{ \begin{matrix}R U L = C y c l e - C y c l {e}_{c {u}_{max}} \\ H I = RUL / Cycl {e}_{max}\end{matrix} \qquad ( 10 )$$

wherein Cycleₘₐₓ is a maximum degradation cycle of the circuit component from the healthy state to complete failure and Cycle_{cu} represents a current degradation cycle. In addition, a similarity model is used to verify stability:

$${D}_{i} = arg \begin{matrix}min \\ t\end{matrix} d ( t , R U {L}_{i} , {M}_{i} ) , i = 1 , 2 , … , n \qquad ( 11 )$$

wherein RULᵢ is the remaining useful life calculated by Equation (10), d(t, RULᵢ, Mᵢ) is a distance function and may be obtained by the Euclidean distance formula, and the smaller the value of Dᵢ, the higher the similarity and the more accurate the remaining useful life.

In Step S6, a network model based on a temporal convolutional network (TCN) and an attention mechanism is adopted to predict the remaining useful life of the circuit component. Step (5) specifically includes the following.

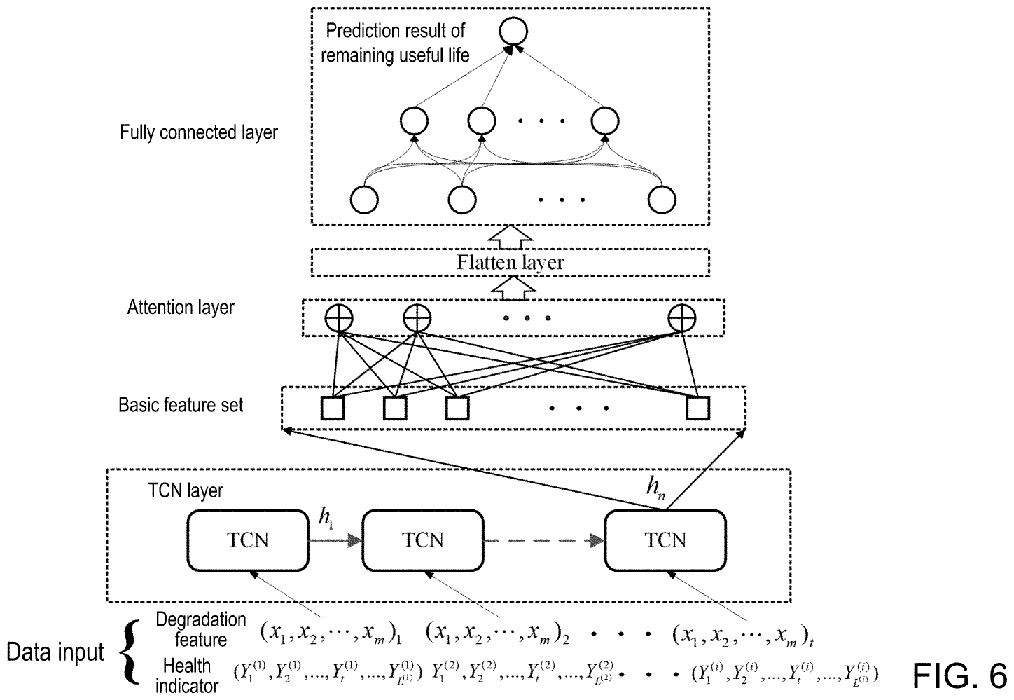

In Step S6.1, a remaining useful life prediction model based on TCN-attention is established, and the model structure is shown in FIG. 6. The network model is divided into three modules, a temporal convolutional network layer, an attention mechanism layer, and a fully connected layer. The TCN network is a new network structure formed by stacking dilated convolutions and causal convolutions while combining residuals. The structure can inherit the advantage of full extraction of convolutional neural networks (CNN), and can be adapted for various timing tasks through controlling parameters such as convolution kernel size and expansion coefficient thereof.

In the embodiment of the disclosure, {(x₁, x₂, . . . , xₘ)₁, (x₁, x₂, . . . , xₘ)₂, . . . (x₁, x₂, . . . , xₘ)ₜ} are input degradation features, wherein (x₁, x₂, . . . , xₘ) represents an input vector, m represents a number of features, and t represents a number of sliding steps. Firstly, through the causal convolutions, which have a strict unidirectional structure. A value of a previous layer at a time T only depends on a value of a next layer at the time T and a previous value thereof. Secondly, one-dimensional full convolutions are used to retain an entire input sequence and construct a long-term memory. Finally, an expansion coefficient d is set in the dilated convolutions and an interval sampling is performed. An expansion convolution operation F on a sequence vector (x₁, x₂, . . . , xₘ)ₛ may be defined as:

$$F ( s ) = {\sum }_{i = 0}^{k - 1} f ( i ) \cdot {( {x}_{1} , {x}_{2} , … , {x}_{m} )}_{s - d \cdot i} \qquad ( 12 )$$

wherein k is a convolution kernel size, s−d·i represents that an (s−d·i)-th element of an upper layer is adopted, and s represents that a certain element in the sequence vector is subjected to a one-dimensional convolution operation.

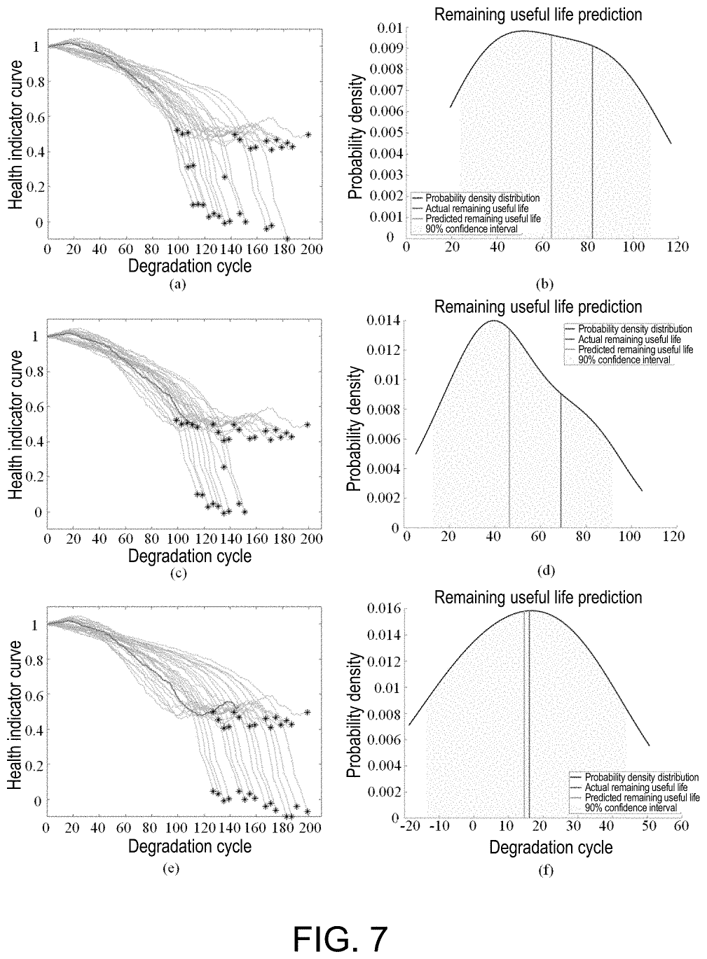

In Step S6.2, in order to further optimize a TCN output feature set, in a second part of the network model, an attention layer is adopted for weight filtering. The specific steps are as follows. Firstly, a similarity scoring is performed on a basic feature set (h₁, h₂, . . . , h_{T}), and a score coefficient vector set is {(s₁, s₂, . . . , s_{N})₁, (s₁, s₂, . . . , s_{N})₂, . . . , (s₁, s₂, . . . , s_{N})_{T}}. Secondly, a Softmax layer is used to perform normalization to obtain a probability coefficient vector set {(∂₁, ∂₂, . . . , ∂_{N})₁, (∂₁, ∂₂, . . . , ∂_{N})₂, . . . , (∂₁, ∂₂, . . . , ∂_{N})_{T}}. Finally, a weighted summation is performed on a basic feature vector, and the result is expressed as (c₁, c₂, . . . , c_{T}), wherein cₖ may be described as:

$${c}_{k} = {\sum }_{i = 0}^{N} {\partial }_{k}^{i} \cdot {x}_{i} \qquad ( 13 )$$

wherein xᵢ represents a hidden unit of the upper layer. A third part of the network model is the prediction model established by connecting a three-layer fully connected network through a flatten layer. The disclosure respectively uses 50%, 70%, and 90% of sample verification data to predict the remaining useful life. As shown in FIG. 7, wherein (a), (c), and (e) respectively represent prediction curves of the remaining useful life obtained when the sample data is 50%, 70%, and 90%, and (b), (d), and (f) respectively represent a probability density distribution of actual remaining useful life and estimated remaining useful life obtained when the sample data is 50%, 70%, and 90%. An error between the predicted remaining useful life and the actual remaining useful life is expressed as:

Eₗ=RUL_{Estimated}−RUL_{Actual} (14)

wherein RUL_{Estimated} and RUL_{Actual} respectively represent the predicted remaining useful life and the actual remaining useful life, and l represents a number of test experiments.

The root mean square error (RMSE) is used to evaluate the prediction accuracy of the remaining useful life. The smaller the RMSE value, the more stable the prediction result. The RMSE equation is as follows:

$$R M S E = \sqrt{\frac{1}{n} {\sum }_{i = 1}^{n} {( {E}_{n} )}^{2}} \qquad ( 15 )$$

The disclosure also provides a system for predicting remaining useful life of an analog circuit, which includes the following.

A degradation variable acquisition module is used to establish a simulation model of the analog circuit, simulate a degradation process of a circuit component through adjusting a value of the circuit component to gradually deviate from a nominal value, and select an output voltage of the circuit as a degradation variable.

A degradation feature extraction module is used to set a tolerance range and a degradation threshold of the circuit component, collect the degradation variable of each degradation cycle, and extract corresponding degradation features.

An optimal feature module is used to establish a feature parameter optimal rule for extracting various analog circuits and preferably select key features that can quantitatively characterize a degree of degradation of the circuit component.

A health indicator curve construction module is used to calculate feature parameter deviations between different degradation states and healthy states of the circuit component to construct a health indicator curve for quantifying the degree of degradation of the circuit component.

A prediction module is used to adopt a prediction model based on a temporal convolutional network (TCN) and an attention mechanism to learn preferably selected key feature data and corresponding health indicator curve data, and predict the remaining useful life of the circuit component.

For the specific implementation of each module, reference may be made to the description of the foregoing embodiment of the method, which will not be repeated in the embodiment of the disclosure.

It should be noted that according to implementation requirements, each step/component described in the disclosure may be split into more steps/components or two or more steps/components or partial operation of a step/component may be combined into a new step/component to implement the objective of the disclosure.

Persons skilled in the art may easily understand that the above are only preferred embodiments of the disclosure and are not intended to limit the disclosure. Any modification, equivalent replacement, improvement, etc., made within the spirit and principle of the disclosure should be included in the protection scope of the disclosure.

What is claimed is:

1. A method for predicting remaining useful life of an analog circuit, comprising:
step (1) of establishing a simulation model of the analog circuit, simulating a degradation process of a circuit component of the analog circuit through adjusting a value of the circuit component to gradually deviate from a nominal value, and selecting an output voltage of the analog circuit as a degradation variable;
step (2) of setting a tolerance range and a degradation threshold of the circuit component, collecting the degradation variable of each degradation cycle, and extracting corresponding degradation features;
step (3) of establishing a feature parameter optimal rule for extracting various analog circuits, and preferably selecting key features that quantitatively characterize a degree of degradation of the circuit component;
step (4) of calculating feature parameter deviations between different degradation states and healthy states of the circuit component to construct a health indicator curve for quantifying the degree of degradation of the circuit component; and
step (5) of adopting a prediction model based on a temporal convolutional network (TCN) and an attention mechanism to learn preferably selected key feature data and corresponding health indicator curve data, and predicting the remaining useful life of the circuit component.

2. The method according to claim 1, wherein step (2) specifically comprises:
adopting a deep learning feature extraction method to extract intermediate layer information as initial features for the degradation variable collected in each degradation cycle;
adopting a feature extraction method based on statistical theory to analyze and process the extracted initial features to obtain the degradation features of the analog circuit;
adopting a feature extraction method based on time domain analysis to analyze and process the extracted initial features to obtain the degradation features of the analog circuit; and
adopting a feature extraction method based on amount of information to analyze and process the extracted initial features to obtain the degradation features of the analog circuit.

3. The method according to claim 1, wherein step (3) specifically comprises:
step (3.1) of comprehensively integrating an optimal feature indicator based on monotonicity of the degradation features of the circuit component and trend of the degradation features of the circuit component to eliminate redundant degradation features that do not change along with the degradation cycle and obtain retained degradation features; and
step (3.2) of adopting a maximum information coefficient (MIC) to calculate a correlation between the retained degradation features to filter out the key features that have deep non-linear correlation between each other in the entire degradation cycle through the maximum information coefficient (MIC), wherein a MIC with higher value represents a higher correlation between the degradation features.

4. The method according to claim 3, wherein step (3.2) specifically comprises:
establishing a correlation symmetric matrix,
$$H = [ \begin{matrix}1 ( {m}_{11} ) & … & {m}_{1 j} & … & {m}_{1 k} & ⋮ & {Mean}_{1} \\ ⋮ & ⋱ & ⋮ & & ⋮ & ⋮ & ⋮ \\ {m}_{j 1} & & 1 ( {m}_{j j} ) & & {m}_{j k} & ⋮ & Mea {n}_{j} \\ ⋮ & & ⋮ & ⋱ & ⋮ & ⋮ & ⋮ \\ {m}_{k 1} & … & {m}_{k j} & … & 1 ( {m}_{k k} ) & ⋮ & Mea {n}_{k}\end{matrix} ] ,$$
wherein mⱼₖ represents a value of the MIC between a j-th degradation feature and a k-th degradation feature, and diagonal values are all 1, wherein
due to symmetry of the matrix, a mean MIC of each line is Mean=(Mean₁, . . . , Meanⱼ, . . . , Meanₖ), wherein Meanⱼ is an indicator for selecting a most optimal feature and reflects a degree of correlation between all other degradation features and the j-th degradation feature, and
$$\{ \begin{matrix}{Mean}_{j} \geq σ \\ σ = \frac{1}{M} {\sum }_{i = 1}^{M} {Mean}_{j}\end{matrix} ,$$
j=1, 2, . . . , M, wherein a is a threshold of optimal features, and M is a number of degradation features participating in correlation calculation.

5. The method according to claim 4, wherein step (4) specifically comprises:
after preferably selecting the key features that can quantitatively characterize the degree of degradation of the circuit component, adopting multi-feature fusion and similarity model to construct the health indicator curve of the circuit component for characterizing the degradation process of the circuit component exceeding the tolerance range; and
determining the degradation thresholds of different circuit components, establishing a database of the health indicator curves of all circuit components, and using the database together with the degradation features as an input of a prediction network.

6. The method according to claim 5, wherein step (5) specifically comprises:
adding health indicator labels to the degradation features after feature optimization to cover the degradation process of a full life cycle of the circuit component from a healthy state to failure and divide into a training set and a test set, inputting the training set into a TCN-attention network for model training, and inputting the test set into a trained model to predict the remaining useful life of the circuit component in a test stage.

7. The method according to claim 6, wherein the TCN-attention network comprises a temporal convolutional network layer, an attention mechanism layer, and a fully connected layer, wherein the temporal convolutional network layer is a new network structure formed by stacking dilated convolutions and causal convolutions while combining residuals.

8. A system for predicting remaining useful life of an analog circuit, comprising:
a degradation variable acquisition module, used to establish a simulation model of the analog circuit, simulate a degradation process of a circuit component of the analog circuit through adjusting a value of the circuit component to gradually deviate from a nominal value, and select an output voltage of the circuit as a degradation variable;
a degradation feature extraction module, used to set a tolerance range and a degradation threshold of the circuit component, collect the degradation variable of each degradation cycle, and extract corresponding degradation features;
an optimal feature module, used to establish a feature parameter optimal rule for extracting various analog circuits and preferably select key features that quantitatively characterize a degree of degradation of the circuit component;
a health indicator curve construction module, used to calculate feature parameter deviations between different degradation states and healthy states of the circuit component to construct a health indicator curve for quantifying the degree of degradation of the circuit component; and
a prediction module, used to adopt a prediction model based on a temporal convolutional network (TCN) and an attention mechanism to learn preferably selected key feature data and corresponding health indicator curve data, and predict the remaining useful life of the circuit component.

9. A computer-readable storage medium stored with a computer program, wherein when the computer program is executed by a processor, the steps of the method according to claim 1 are implemented.

10. The method according to claim 2, wherein step (3) specifically comprises:
step (3.1) of comprehensively integrating an optimal feature indicator based on monotonicity of the degradation features of the circuit component and trend of the degradation features of the circuit component to eliminate redundant degradation features that do not change along with the degradation cycle and obtain retained degradation features; and
step (3.2) of adopting a maximum information coefficient (MIC) to calculate a correlation between the retained degradation features to filter out the key features that have deep non-linear correlation between each other in the entire degradation cycle through the maximum information coefficient (MIC), wherein a MIC with higher value represents a higher correlation between the degradation features.

11. A computer-readable storage medium stored with a computer program, wherein when the computer program is executed by a processor, the steps of the method according to claim 2 are implemented.

12. A computer-readable storage medium stored with a computer program, wherein when the computer program is executed by a processor, the steps of the method according to claim 3 are implemented.

13. A computer-readable storage medium stored with a computer program, wherein when the computer program is executed by a processor, the steps of the method according to claim 4 are implemented.

14. A computer-readable storage medium stored with a computer program, wherein when the computer program is executed by a processor, the steps of the method according to claim 5 are implemented.

15. A computer-readable storage medium stored with a computer program, wherein when the computer program is executed by a processor, the steps of the method according to claim 6 are implemented.

16. A computer-readable storage medium stored with a computer program, wherein when the computer program is executed by a processor, the steps of the method according to claim 7 are implemented.
